(19) United States
(12) Patent Application Publication
(10) Pub. No.: US 2021/0365899 A1
(43) Pub. Date: Nov. 25, 2021

(54) STREAMLINED RECORD ASSOCIATION AND UPDATES

(71) Applicant: ZEBRA TECHNOLOGIES CORPORATION, Lincolnshire, IL (US)

(72) Inventor: Michael P. Cote, Princeton, MA (US)

(21) Appl. No.: 16/880,734

(22) Filed: May 21, 2020

(51) Int. Cl. G06Q 10/00

(52) U.S. Cl. CPC G06Q 10/30

(57) ABSTRACT

A method includes: receiving, from a first client device, an action record containing an identifier of the first client device, and one of a set of action identifiers indicating a completed action from a sequence; obtaining a first sequence record corresponding to the action record, and containing a first sequence identifier corresponding to the sequence, and the set of action identifiers; updating the first sequence record to include the first client device identifier in association with the one action identifier; identifying a second sequence record containing a second sequence identifier distinct from the first sequence identifier, and the set of action identifiers; when the second sequence record satisfies an association criterion, automatically updating the second sequence record to include the first client device identifier in association with the one action identifier; and responsive to determining that at least one of the first and second sequence records indicates a completion of the sequence of actions, generation an output control signal.

### BACKGROUND

Certain systems rely on the completion of diverse actions by disparate sets of entities to generate system output. Collection and processing of data from those entities may be computationally costly.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for record association and updating.

FIG. 2 is a block diagram of certain components of the aggregator of FIG. 1.

FIG. 3 is a flowchart of a record association method.

FIG. 4A is a diagram illustrating an example performance of blocks 305 and 310 of the method of FIG. 3.

FIG. 4B is a diagram illustrating an example performance of block 315 of the method of FIG. 3.

FIG. 5 is a diagram illustrating a repository of the aggregator of FIG. 1 following a plurality of performances of the method of FIG. 3.

FIG. 6A is a diagram illustrating an example performance of block 315 of the method of FIG. 3.

FIG. 6B is a diagram illustrating an example performance of block 330 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In some systems, generation of an output depends on completion of a sequence of actions taken by disparate entities. The output itself may take a wide variety of forms, including control signals to machinery, message generation, initiation of a financial transaction, and the like.

Detecting whether or when the sequence of actions has been completed in order to generate the relevant output may, for example, be accomplished by collecting data from the above-mentioned entities and determining correlations in the data. However, substantial volumes of such actions may occur, defining a significant number of individual sequences, each leading to distinct outputs. Submitting data corresponding to actions taken, as well as processing the received reporting data to detect sequence completion, may impose costly computational and/or storage burdens on the various entities implementing the system.

For example, a system may be deployed to track and/or encourage recycling of packaging material such as cardboard boxes. Item of packaging material may be used by vendors or producers of items, to package the items for delivery to consumers. The consumers, in turn, may physically transfer the packaging material to processing entities such as recyclers (e.g. via curbside pickup by a recycler). The completion of the above-mentioned sequence, in which a cardboard box is produced (or put into use if previously produced), transferred to a consumer, then transferred to a recycler, may lead to various forms of system output. The system output in such implementations can include incentives distributed to the entities involved, e.g. in the form of financial transactions.

Generation of system output in the above scenario, however, involves collecting data defining each action in the sequence, for each item of packaging material. As will be apparent, the volume of such data may be substantial. In addition, the collection of such data, particularly by entities such as the recyclers, may cause significant operational delays, e.g. resulting from a requirement to submit information to a tracking system for each item of packaging material collected during curbside pickup.

Examples disclosed herein are directed to a method, comprising: receiving, at an aggregator from a first client device, an action record containing (i) an identifier of the first client device, and (ii) one of a set of action identifiers indicating a completed action of a sequence of actions; obtaining a first sequence record corresponding to the action record, the first sequence record containing (i) a first sequence identifier corresponding to the sequence of actions, and (ii) the set of action identifiers; updating the first sequence record to include the identifier of the first client device in association with the one action identifier indicating the completed action; identifying a second sequence record containing (i) a second sequence identifier distinct from the first sequence identifier, and (ii) the set of action identifiers; when the second sequence record satisfies an association criterion, automatically updating the second sequence record to include the identifier of the first client device in association with the one action identifier indicating the completed action; and responsive to determining that at least one of the first and second sequence records indicates a completion of the sequence of actions, generation an output control signal.

Other examples disclosed herein are directed to a computing device, comprising: a memory; a communications interface; and a controller configured to: receive, from a first client device via the communications interface, an action record containing (i) an identifier of the first client device, and (ii) one of a set of action identifiers indicating a completed action of a sequence of actions; obtain a first sequence record corresponding to the action record, the first sequence record containing (i) a first sequence identifier corresponding to the sequence of actions, and (ii) the set of action identifiers; update the first sequence record to include the identifier of the first client device in association with the one action identifier indicating the completed action; identify a second sequence record containing (i) a second sequence identifier distinct from the first sequence identifier, and (ii) the set of action identifiers; when the second sequence record satisfies an association criterion, automatically update the second sequence record to include the identifier of the first client device in association with the one action identifier indicating the completed action; and responsive to determining that at least one of the first and second sequence records indicates a completion of the sequence of actions, generate an output control signal.

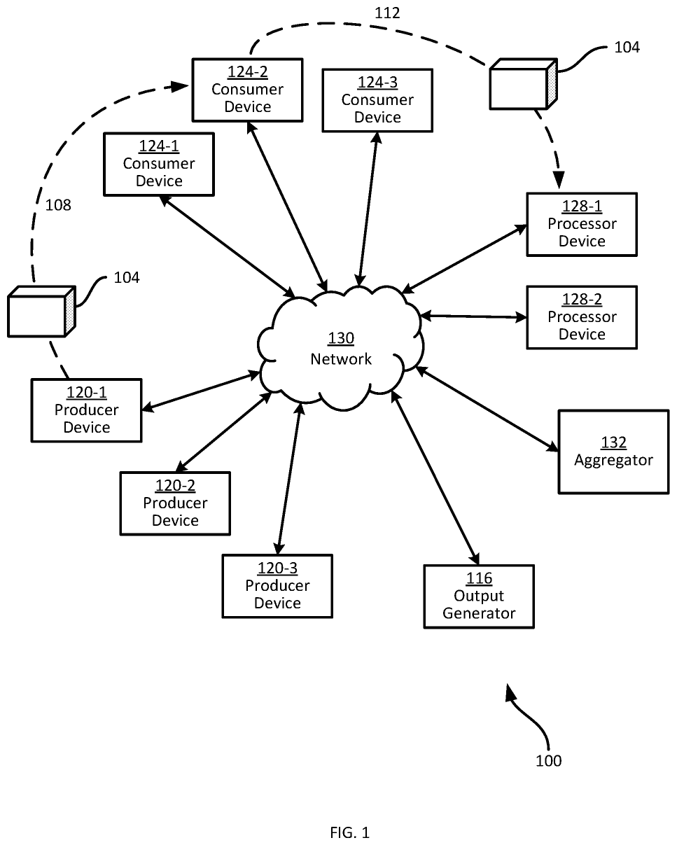

FIG. 1 shows a system 100 for streamlined record association and updating. The system 100 includes a plurality of computing devices operated to collect and process data defining a sequence of actions that, when completed, leads to the generation of a system output. The nature of the sequence of actions, and of the output generated by the system 100 upon completion of the sequence, is not particularly limited. However, for the purpose of illustrating the functionality of the system 100, the system 100 will be described below in conjunction with its use to track a sequence of actions corresponding to the recycling of packaging material such as a cardboard box 104.

The box 104 may be put into use at a vendor, shipper or other similar entity, where the box 104 may be used to package items for shipment to a consumer, as illustrated via the dashed line 108. Following delivery of the items, the box 104 may be discarded by the consumer and collected by a processing entity such as a recycler, as illustrated via the dashed line 112. The system may be enabled to track the physical transfers of the box 104 from vendor to consumer, and from consumer to recycler. The above-mentioned transfers may also be referred to as a sequence of actions. In the present example, the sequence includes three actions: initiation (i.e. initiating use of the box 104 to ship items), transfer for recycling (e.g. placement for curbside pickup at a consumer location), and processing by the recycler (e.g. collection for subsequent processing).

As will be apparent, a plurality of such sequences may be in progress at any given time, with each sequence corresponding to a particular box or other item of packaging material. An output generator entity (e.g. a governmental entity or the like) may collect and process data defining the above sequences, and generate output control signals or other data in response to each sequence completion. For example, the output control signals may be initiations of financial transactions to provide rewards to one or more of the vendors, consumers and recyclers. In other implementations directed to sequences of actions such as multi-stage industrial processes, the output control signals may control machinery, for example.

The output generator may perform the above collection and processing via a computing device 116. The other entities in the system 100 may also operate computing devices to enable the data collection and processing functionality mentioned above. For example, the vendor/producer entities mentioned above may operator computing devices 120, of which three examples 120-1, 120-2 and 120-3 are shown in FIG. 1. The consumer entities mentioned above, meanwhile, operate consumer computing devices 124, of which three examples 124-1, 124-2 and 124-3 are shown in FIG. 1. Further, the processing entities such as recyclers operate computing devices 128, of which two examples 128-1 and 128-2 are shown in FIG. 1. As will be apparent, the system 100 can include greater or smaller numbers of the above devices and operating entities.

The computing devices 120, 124 and 128 can include any of a variety of computing devices, including laptop computers, tablet computers, smart phones, and the like. In some examples, the computing devices 120, 124 and 128 include data capture modules such as barcode scanners, to aid in the collection of data for use in tracking the sequences of actions noted above. For example, each device 120 may be configured to transmit data defining the shipping of a box to a consumer. Further each consumer device 124 may be configured to transmit data defining the deposit of a box for collection by a recycler, and each device 128 may be configured to transmit data

The data transmitted by the devices 120, 124 and 128 may be received at the computing device 116 via a network 130 and processed by the computing device 116 to detect completion of action sequences (e.g. delivery of the box 104 to a consumer and then to a recycler). For example, each action reported by the devices 120, 124 and 128 may include an identifier of the sending device, and an identifier associated with the box (e.g. the box 104). The computing device 116 may therefore determine that a sequence has been completed when one device 120, one device 124, and one device 128 have all transmitted data to the computing device 116 containing the identifier of the box 104, indicating that the box has been transferred from a vendor to a recycler via a consumer.

As will be apparent, the above process depends on each movement of each item of packaging material being collected and submitted to the computing device 116. The volume of packaging material handled by some entities (e.g. recyclers) may be sufficiently large that collecting and transmitting data for each piece of material may be prohibitively costly. Further, the volume of data to be processed by the computing device 116 may also impose undesirably high computational costs.

The system 100 therefore also includes a server 132, also referred to as an aggregator 132, configured to collect data from the devices 120, 124 and 128 (which may generally be referred to as client devices) and to perform certain correlations between such data automatically, in the absence of data confirming such correlations. The volume of data collected via the client devices may therefore be reduced, and the volume of data processed by the aggregator 132 may also be reduced. The computing device 116 may query the aggregator 132 to detect completed sequences of actions and generate the above-mentioned output.

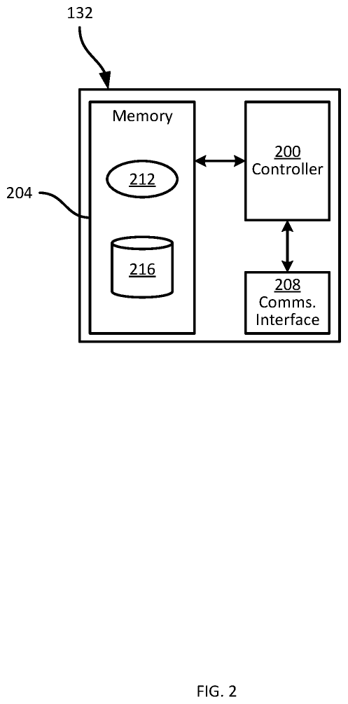

Turning to FIG. 2, certain components of the aggregator 132 are illustrated. The aggregator 132 includes a controller 200 such as a central processing unit (CPU) connected with a non-transitory computer readable storage medium, such as a memory 204. The memory 204 includes any suitable combination of volatile memory (e.g. Random Access Memory (“RAM”)) and non-volatile memory (e.g. read only memory (“ROM”), Electrically Erasable Programmable Read Only Memory (“EEPROM”), flash memory). In general, the controller 200 and the memory 204 each comprise one or more integrated circuits.

The aggregator 132 also includes a communications interface 208 enabling the aggregator to communicate with other computing devices, e.g. via the network 130. The communications interface 208 includes any suitable combination of hardware elements (e.g. network interface controllers and the like) and corresponding firmware and/or software for controlling such components.

Although the aggregator 132 is illustrated as a discrete computing device, containing the above-mentioned components in a single physical enclosure, in other embodiments, the aggregator 132 is implemented as a distributed computing device in which the above-mentioned components are implemented on a plurality of underlying hardware devices (e.g. a plurality of controllers 200 and associated memories 204).

The memory 204 stores a plurality of instructions for execution by the controller 200 to implement functionality related to the sequence tracking and output generation mentioned above. In particular, the memory 204 stores a record processing application 212, whose execution by the controller 200 configures the controller 200 to receive data from the client devices 120, 124 and 128, and streamline the association of such records for subsequent processing by the computing device 116. The memory 204 also stores a repository 216 containing data received from the client devices 120, 124 and 128.

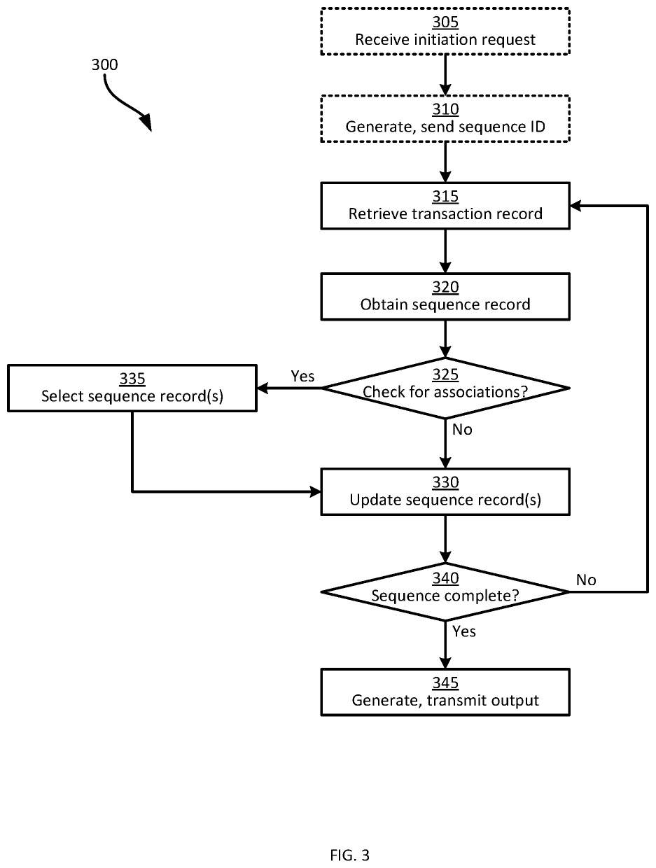

Turning to FIG. 3, the operation of the system 100 will be discussed in greater detail. In particular, FIG. 3 illustrates a method 300 of streamlining data record association, which will be discussed in conjunction with its performance by the aggregator 132 via execution of the application 212.

At block 305, the aggregator 132 receives an initiation request via the network 130, e.g. from one of the computing devices 120. The initiation request initiates tracking of a particular sequence of actions, such as the transfers of a particular package. In the present example, the computing device 120-1 may send the initiation request when the vendor entity operating the computing device 120-1 is preparing to send the box 104 to a consumer.

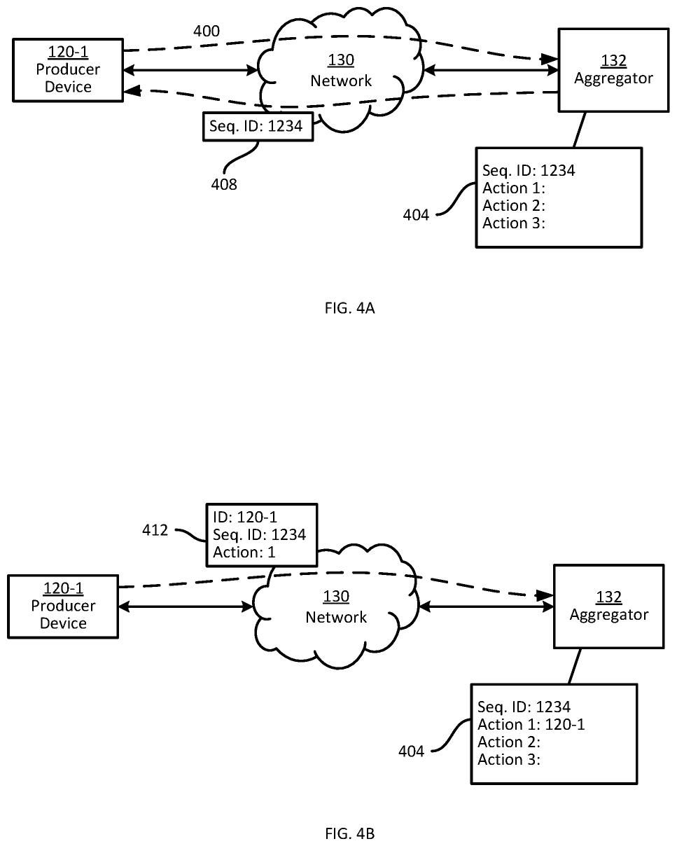

In response to the initiation request, the aggregator 132 is configured to generate a sequence identifier and return the sequence identifier to the device from which the request received at block 350 originated. The aggregator 132 is also configured to create a sequence record and store the sequence record in the repository 216 at block 310. Referring briefly to FIG. 4A, a simplified view of the system 100 is illustrated, in which the device 120-1 transmits an initiation request 400 to the aggregator 132. In response, at block 310, the aggregator 132 generates a sequence identifier (e.g. “1234”) and a sequence record 404 in the repository 216. The sequence record 404 contains the sequence identifier, as well as a set of action identifiers. The set of action identifiers, indicated as “Action 1”, “Action 2” and “Action 3” in FIG. 4A, correspond to the actions necessary to complete the sequence. In the present example, the action identifiers may correspond, respectively, to the shipping of the box 104 to a consumer, the deposit of the box 104 for pickup by a recycler, and the collection of the box 104 for recycling by a recycler.

The action identifiers created in a sequence record can be preconfigured at the aggregator 132. For example, if the aggregator 132 is configured to track various types of sequences (e.g. on behalf of different computing devices 116 and sets of client devices 120, 124 and 128), the initiation request may also specify the type of sequence being initiated.

As noted above, at block 310 the sequence identifier itself is also transmitted to the device 120-1, e.g. in a message 408. The sequence identifier may be used at the vendor operating the device 120-1 to mark the box 104, e.g. by encoding the sequence identifier in a barcode or other indicium on a label applied to the box 104. The nature of the sequence identifier is not particularly limited. In some examples, the sequence identifier is a substantially unique identifier (e.g. a UUID or GUID). As will be discussed in greater detail below, marking the box 104 with the sequence identifier enables subsequent actions involving the box 104 to be associated with each other by the aggregator 132.

Returning to FIG. 3, at block 315 the aggregator 132 receives a transaction record via the network 130 from one of the client devices 120, 124 and 128. The transaction record contains an identifier of the client device and one of the above-mentioned set of action identifiers, indicating completion of that action by an entity operating the relevant client device. In the present example, a transaction record is received at block 315 from the device 120-1 when the box 104, with the sequence identifier affixed thereto, is shipped to a consumer.

FIG. 4B illustrates an example performance of block 315, in which the aggregator 132 receives a transaction record 412 (which may also be referred to simply as an action record 412) from the device 120-1. The transaction record 412 contains an identifier of the device 120-1 itself (“120-1” in this example), as well as the sequence identifier from block 310 and one of the set of action identifiers mentioned earlier. The transaction record may also include a timestamp. In the present example, the action identifier “1” is included in the transaction record 412, indicating completion of the first action in the sequence (i.e. shipping of the box 104 to a consumer). In other examples, the action identifier may be implicitly indicated by the client device identifier. For example, the aggregator 132 may store a list of client devices and actions associated with each client device (as each client device is generally associated with a single action).

At block 320, the aggregator 132 obtains the sequence record corresponding to the transaction record received at block 315. In the present example, the performance of block 320 includes retrieving the sequence record 404 from the repository 216. In some examples, the performance of blocks 305 and 310 can be omitted, and the sequence record 404 can be created at block 315. In such examples, the client device 120-1 itself generates the sequence identifier and transmits the sequence identifier to the aggregator 132, e.g. in the transaction record. The sequence identifier may be selected as a random number sufficiently great to be substantially globally unique. The sequence identifier may also be based at least in part on hardware characteristics of the device 120-1, such as a media access control (MAC) address of the device 120-1.

Having retrieved or created the sequence record 404 at block 315, the aggregator 132 is configured to determine, at block 325, whether to search for other sequence records in the repository 216 to update according to the transaction record 412. That is, although each transaction record received at block 315 relates to a given sequence, under certain conditions the aggregator 132 updates sequence records corresponding to other sequences, thus reducing the volume of data to be collected by the client devices 120, 124 and 128.

The determination at block 325 can be based on the action identifier of the transaction record from block 315. For example, the aggregator 132 may be configured to search for associated sequence records only in response to transaction records for specific actions. In the present example, the aggregator 132 is configured to make an affirmative determination at block 325 only when the action identifier in the transaction record received at block 315 is “3”. The determination at block 325 is therefore negative, and the aggregator 132 proceeds to block 330. Further discussion of the determination at block 325, as well as block 335, at which other sequence records are selected for updating, will be provided later herein.

At block 330, the aggregator 132 updates the sequence record obtained at block 320. In the present example, therefore, the sequence record 404 is updated according to the transaction record 412. As shown in FIG. 4B, the sequence record 404 is updated to include the client identifier (“120-1”) from the transaction record 412 in association with the action identified in the transaction record 412. That is, the sequence record 404 as updated in FIG. 4B indicates that the first of three stages in the sequence has been completed and recorded by the device 120-1.

At block 340, the aggregator 132 can be configured to determine whether the sequence tracked via the sequence record 404 is complete. Since two of the action identifiers in the sequence record 404 are not yet associated with client device identifiers, the determination at block 340 is negative in the present example. The aggregator 132 therefore returns to block 315 to await further transaction records.

Once the box 104 reaches a consumer (e.g. the consumer associated with the device 124-2, the box 104 may be deposited for curbside pickup or other delivery to a recycler. The device 124-2 may be operated, when the box is ready for transfer to a recycler, to capture the sequence identifier by scanning the above-mentioned label affixed to the box 104. In response to capturing the sequence identifier, the device 124-2 generates a further transaction record, which is received at the aggregator 132 at a further performance of block 315. In particular, the transaction record includes the sequence identifier “1234”, the identifier of the device 124-2 itself, and an action identifier. In this example, the action identifier is “2”, corresponding to the second action in the predefined sequence.

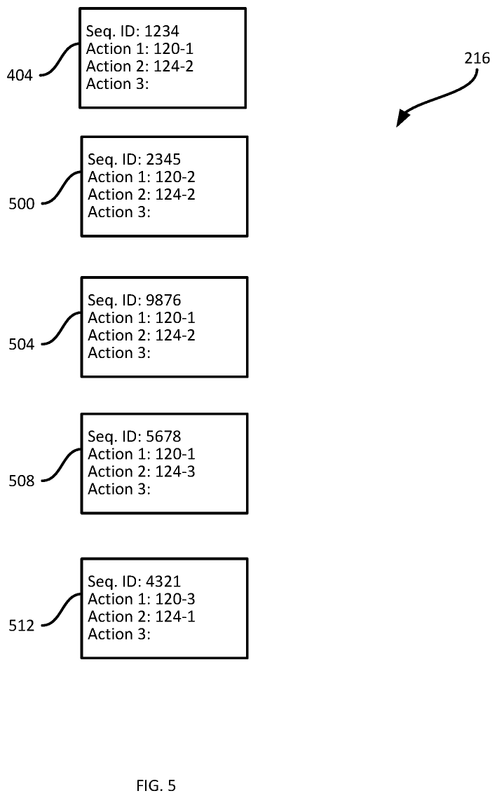

The determination at block 325 in response to receiving such a transaction record is negative, as in the present example the determination at block 325 is affirmative only for transaction records with the action identifier “3”. At block 330, the sequence record 404 is further updated as shown in FIG. 5, to include the client device identifier “124-2” in association with the second action identifier.

It is assumed that, prior to completion of the sequence tracked by the sequence record 404, a plurality of additional sequences are initiated. Sequence records 500, 504, 508 and 512 are illustrated in FIG. 5. As will be apparent, the sequence records 500-512 arise from additional performances of the method 300. Certain sequence records, such as the records 500 and 504, track the transfer of additional boxes received by the consumer associated with the device 124-2.

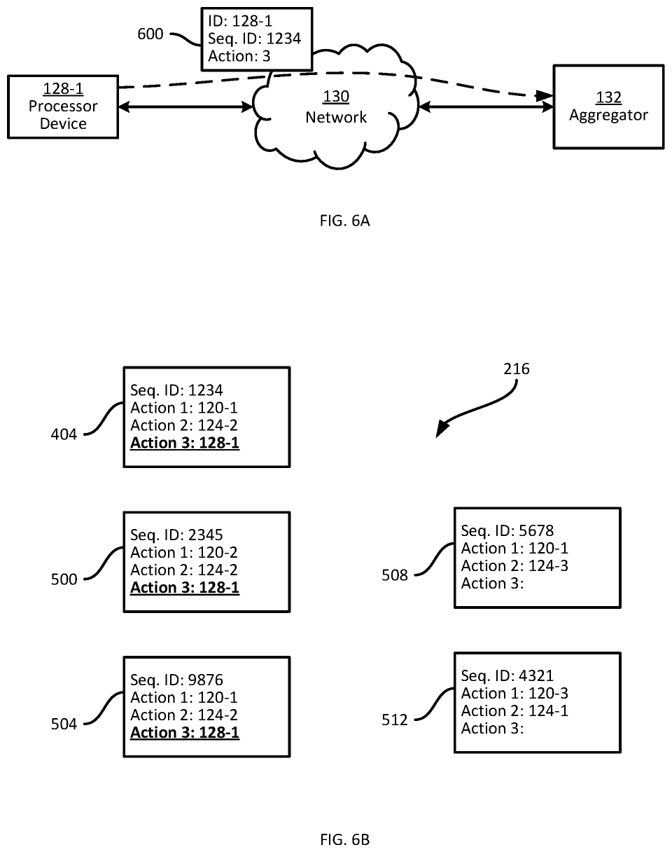

At a further performance of block 315, the aggregator 132 receives a transaction record from the device 128-1, operated by a recycler. As shown in FIG. 6A, a transaction record 600 received from the device 128-1 includes the identifier of the device 128-1, as well as the sequence identifier “1234” and an action identifier. The sequence identifier can be obtained by scanning the above-mentioned indicium on the box 104, e.g. via a data capture module of the device 128-1. The device 128-1 may, for example, by operated by staff of the recycler responsible for curbside pickup of boxes and other material for recycling at a location associated with the device 124-2 (e.g. a consumer's house).

Following receipt of the transaction record 600, the sequence record 404 is retrieved at block 320, and the determination at block 325 is affirmative. The aggregator 132 therefore proceeds to block 335. At block 335, the aggregator 132 is configured to select, from the repository, additional sequence records that correspond to different sequences (i.e. that track the transfers of different boxes). In particular, the sequence records selected at block 335 can include those that do not contain device identifiers in connection with the third action (i.e. have not yet been completed), but contain the same device identifier associated with the second action as the sequence record 404.

As will be apparent, a plurality of items of packaging material such as the box 104 may be deposited for curbside pickup or other collection at a given location (e.g. the residence associated with the device 124-2). The same processing entity, such as the recycler associated with the device 128-1, is generally responsible for collection of all packaging items at a given location. Therefore, the aggregator 132 is configured to retrieve sequence records at block 335 that are likely to also have been collected when the transaction record 600 is received indicating that the box 104 has been collected.

Sequence records may be selected at block 335 according to a variety of criteria, including a shared device identifier for the second action as noted above. For example, the sequence records selected at block 335 may additionally include timestamps associated with their second actions that are within a predefined time period (e.g. one week). In the present example, as shown in FIG. 5, the sequence records 500 and 504 also indicate that additional packaging items were placed for collection at a location associated with the device 124-2. The records 500 and 504 are therefore selected at block 335.

At block 330, the sequence record retrieved at block 320, as well as any sequence records selected at block 335, are updated according to the transaction record from block 315. Therefore, as shown in FIG. 6B, the sequence records 404, 500 and 504 are updated to include the device identifier “128-1” in response to receipt of the transaction record 600. In other words, three sequence records are updated in response to a single transaction record from the device 128-1, relieving the device 128-1 from the need to also scan the packaging items associated with the records 500 and 504. Thus, the device 128-1 may be operated to scan only one packaging item per location, and the aggregator 132 updates the repository 216 based on an assumption that other items at the same location have likely also been collected.

At a further performance of block 340, the determination is affirmative, as the sequence record 404 includes client device identifiers associated with all three action identifiers. As will be apparent from FIG. 6B, determinations at block 340 are also affirmative for the records 500 and 504.

Following an affirmative determination at block 340, the aggregator 132 generates and transmits output control signals corresponding to the completed sequence. The output control signal may include transmitting the sequence record 404 to the computing device 116 for further processing, e.g. to initiate a financial transaction or other reward to one or more of the devices 128-1, 124-2 and 120-1. The output control signal may also include the initiation of the such transactions by the aggregator 132 itself, in some examples.

In other embodiments, the repository 216 may be implemented as a distributed ledger rather than maintained solely by the aggregator 132. For example, the aggregator 132 and/or the computing devices 120, 124 and 128 (as well as the computing device 116) may act as nodes maintaining the distributed ledger. In such examples, the performance of blocks 325, 330 and 335 to update sequence records may be implemented by the node submitting a transaction to the distributed ledger, or by another node via execution of a smart contract encoded in the ledger.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
receiving, at an aggregator from a first client device, an action record containing (i) an identifier of the first client device, and (ii) one of a set of action identifiers indicating a completed action of a sequence of actions;
obtaining a first sequence record corresponding to the action record, the first sequence record containing (i) a first sequence identifier corresponding to the sequence of actions, and (ii) the set of action identifiers;
updating the first sequence record to include the identifier of the first client device in association with the one action identifier indicating the completed action;
identifying a second sequence record containing (i) a second sequence identifier distinct from the first sequence identifier, and (ii) the set of action identifiers;
when the second sequence record satisfies an association criterion, automatically updating the second sequence record to include the identifier of the first client device in association with the one action identifier indicating the completed action; and
responsive to determining that at least one of the first and second sequence records indicates a completion of the sequence of actions, generating an output control signal.

2. The method of claim 1, wherein obtaining the first sequence record includes creating the first sequence record in response to receiving the action record.

3. The method of claim 1, further comprising:
prior to receiving the action record, receiving a sequence initiation request;
creating a sequence record with the first sequence identifier; and
sending the first sequence identifier in response to the initiation request.

4. The method of claim 3, wherein the action record includes the first sequence identifier; and wherein obtaining the first sequence record includes retrieving the first sequence record based on the first sequence identifier.

5. The method of claim 1, further comprising:
prior to identifying the second sequence record, determining that the action identifier of the action record matches a predefined action identifier.

6. The method of claim 1, wherein the association criterion includes another client device identifier shared with the first sequence record.

7. The method of claim 6, wherein the association criterion further includes a time period encompassing action completions of the first sequence record and the second sequence record.

8. The method of claim 1, wherein determining that the first sequence record indicates a completion of the sequence of actions includes: determining that each of the action identifiers in the first sequence record is associated with a client device identifier.

9. A computing device, comprising:
a memory;
a communications interface; and
a controller configured to:
receive, from a first client device via the communications interface, an action record containing (i) an identifier of the first client device, and (ii) one of a set of action identifiers indicating a completed action of a sequence of actions;
obtain a sequence record corresponding to the action record, the sequence record containing (i) a first sequence identifier corresponding to the sequence of actions, and (ii) the set of action identifiers;
update the sequence record to include the identifier of the first client device in association with the one action identifier indicating the completed action;
identify a second sequence record containing (i) a second sequence identifier distinct from the first sequence identifier, and (ii) the set of action identifiers;
when the second sequence record satisfies an association criterion, automatically update the second sequence record to include the identifier of the first client device in association with the one action identifier indicating the completed action; and
responsive to determining that at least one of the first and second sequence records indicates a completion of the sequence of actions, generate an output control signal.

10. The computing device of claim 9, wherein the controller is configured to obtain the sequence record by creating the first sequence record in response to receiving the action record.

11. The computing device of claim 9, wherein the controller is further configured to:
prior to receiving the action record, receive a sequence initiation request;
create a sequence record with the first sequence identifier; and
send the first sequence identifier in response to the initiation request.

12. The computing device of claim 11, wherein the action record includes the first sequence identifier; and wherein the controller is configured to obtain the first sequence record by retrieving the first sequence record based on the sequence identifier.

13. The computing device of claim 9, wherein the controller is further configured to:
prior to identifying the second sequence record, determine that the action identifier of the action record matches a predefined action identifier.

14. The computing device of claim 9, wherein the association criterion includes another client device identifier shared with the first sequence record.

15. The computing device of claim 14, wherein the association criterion further includes a time period encompassing action completions of the first sequence record and the second sequence record.

16. The computing device of claim 9, wherein the controller is configured to determine that the first sequence record indicates a completion of the sequence of actions by: determining that each of the action identifiers in the first sequence record is associated with a client device identifier.
